(19) United States
(12) Patent Application Publication
(10) Pub. No.: US 2008/0047410 A1
(43) Pub. Date: Feb. 28, 2008

(54) Quickly collapsible dividing plate base unit for a table sawing machine

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/509,799

(22) Filed: Aug. 25, 2006

(51) Int. Cl. B23D 19/00; B26D 1/14

(52) U.S. Cl. 83/469

(57) ABSTRACT

A quickly collapsible dividing plate unit for a table sawing machine includes a dividing plate, a fixing base, a hexagonal bolt and a spanner unit. The hexagonal bolt has a head, a fitting projection on the head and a threaded hole in the center of the fitting projection. The spanner unit is composed of a spanner and a screw, and the spanner has a fitting hole in a front end to fit around the fitting projection of the hexagonal bolt, with the screw passing the fitting hole and engaging with the threaded hole so the spanner may be threadably combined with the hexagonal bolt. Then the spanner is handled to fix or loosen quickly the hexagonal bolt so that the dividing plate base unit may quickly be assembled or collapsed.

### BACKGROUND OF THE INVENTION

1. Field of the invention

This invention relates to a table sawing machine, particularly to one provided with a quickly collapsible dividing plate base unit.

2. Description of the Prior Art

A conventional table sawing machine shown in FIG. 1 includes a dividing plate base unit 10, which is composed of a dividing plate 11, a fixing base 12 and a hexagonal bolt 13. The fixing base 12 is fixed in an inside of the machine body 1, provided with a threaded hole 121 in one side, and two corresponding slide grooves 122 vertically at two ends. The dividing plate 11 has a positioning portion 111 in a lower end to fit between the two slide grooves 122 of the fixing base 12, and an elongate slot 112 in the lower end to face to the threaded hole 121 of the fixing base 12. Then the hexagonal bolt 13 extends through the elongate slot 112 and engages with the threaded hole 121 of the fixing base 12. Thus the dividing plate 11 is tightly combined with the fixing base 12 with the hexagonal bolt 13.

However, to collapse the dividing plate 11, a tool has to be used for the hexagonal head 131 of the bolt 13 for loosening the hexagonal bolt 13. So it takes some time to choose the tool for collapsing the dividing plate 11 from the fixing base 12, not convenient.

### SUMMARY OF THE INVENTION

This invention has been devised to offer a quickly collapsible dividing plate base unit for a table sawing machine.

The feature of the invention is a dividing plate, a fixing base, a hexagonal bolt and a spanner unit. The hexagonal bolt has a fitting end and a threaded hole in the center of the fitting end. The spanner unit is composed of a spanner and a screw, and the spanner has a fitting member in a front end to fit with the fitting end of the hexagonal bolt. The screw passes through the fitting member and engages with the threaded hole so that the spanner can be threadably combined with the hexagonal bolt. Then the spanner is handled manually to assemble and collapse quickly the dividing plate base unit, without using any tool, saving time and upgrading working effect.

### BRIEF DESCRIPTION OF DRAWINGS

This invention will be better understood by referring to the accompanying drawings, wherein:

FIG. 1 is a perspective view of a dividing plate base of a conventional table sawing machine;

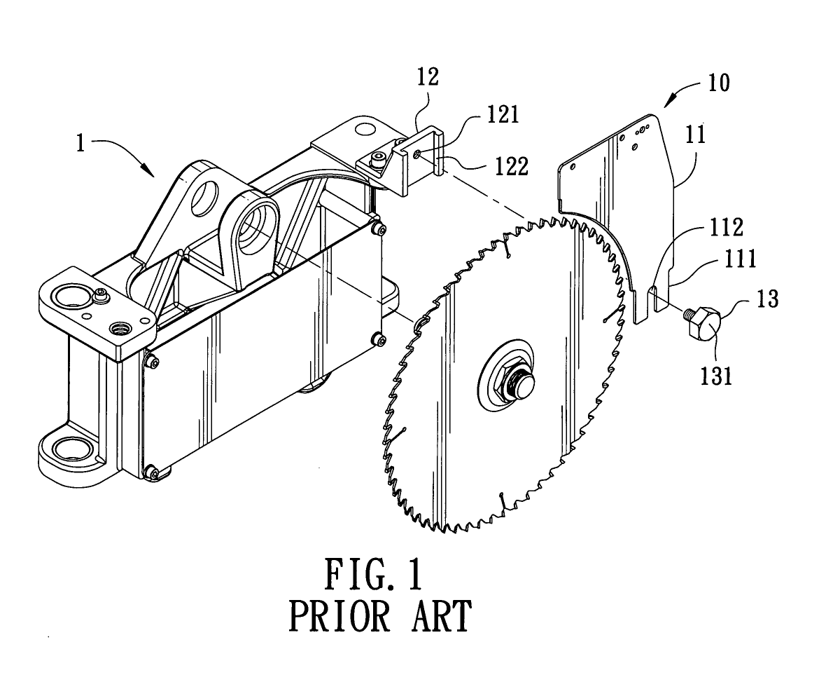

FIG. 2 is a perspective view of a first preferred embodiment of a table sawing machine provided with a quickly collapsible dividing plate base in the present invention;

FIG. 3 is an exploded perspective view of the quickly dividing plate base of the first embodiment in the present invention;

FIG. 4 is a cross-sectional view of the quickly collapsible dividing plate base in the first embodiment in the present invention;

FIG. 5 is a side view of the quickly collapsible dividing plate base in the first embodiment being under collapsed condition in the present invention;

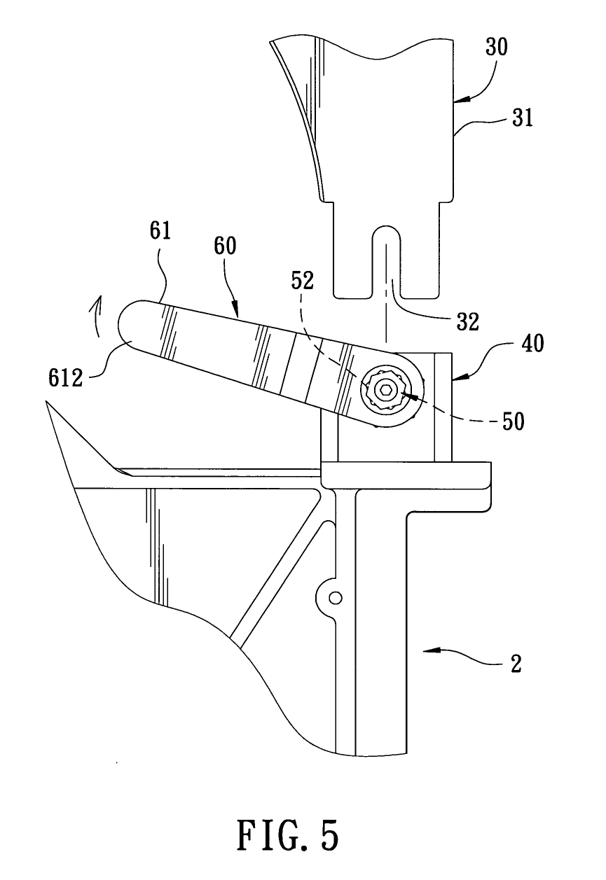

FIG. 6 is a side view of the quickly collapsible dividing plate base in the first embodiment being under combined condition in the present invention; and,

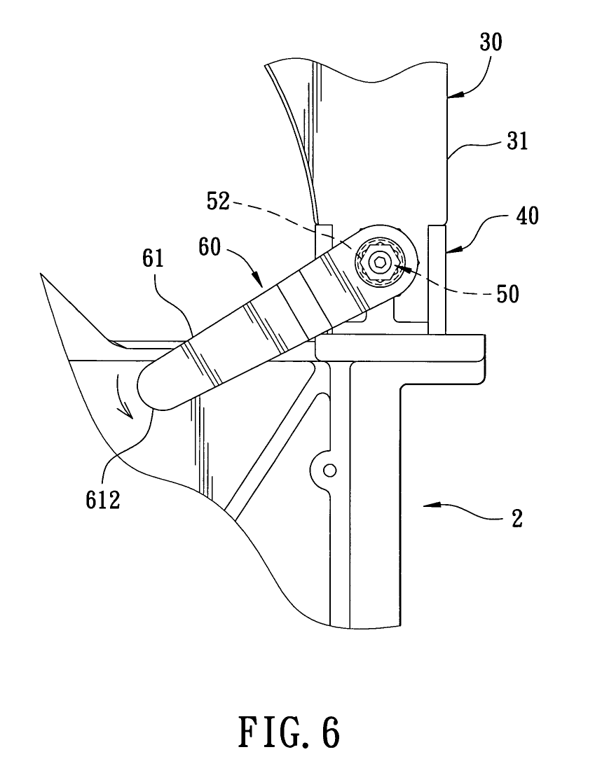

FIG. 7 is an exploded perspective view of a second preferred embodiment of a quickly collapsible dividing plate base in the present invention.

### DETAILED DESCRIPTION OF THE PREFERRED EMBODIMENTS

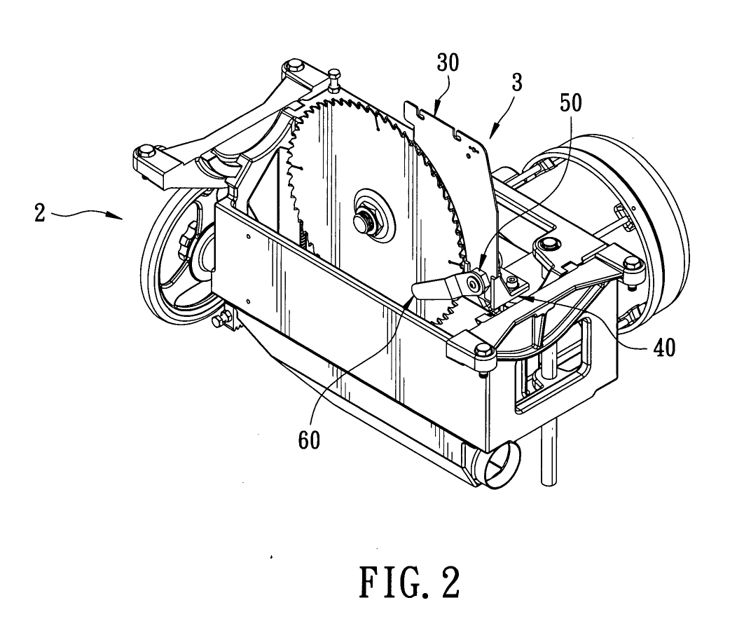

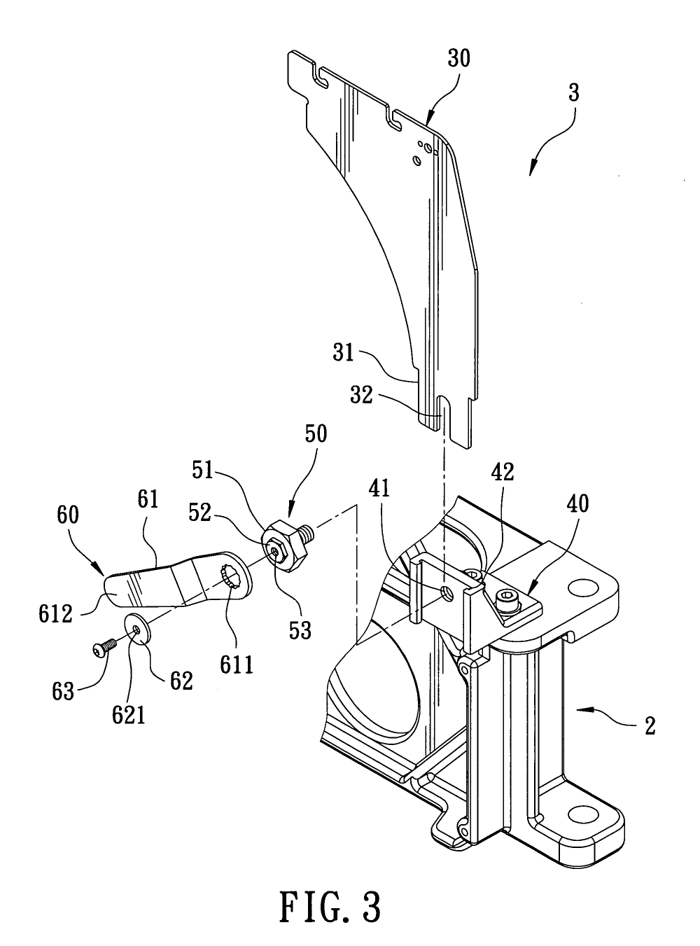

A first preferred embodiment of a quickly collapsible dividing plate base for a table sawing machine in the present invention, as shown in FIGS. 2 and 3, includes a dividing plate base unit 3, which is composed of a dividing plate 30, a fixing base 40, a hexagonal bolt 50 and a spanner unit 60.

The dividing plate 30 is provided with a positioning portion 31 in a lower end and an elongate slot 32 in the intermediate portion of the lower end.

The fixing base 40 is fixed inside of the machine body 2, provided with a threaded hole 41 in one side to correspond to the elongate slot 32 of the dividing plate 30, and the hexagonal bolt 50 passes through the elongate slot 32 and then engages with the threaded hole 41 of the fixing base 40.

The hexagonal bolt 50 has a head 51 and a fitting hexagonal projection 52 formed on the upper surface of the head 51 and a threaded hole 53 bored in the center of the fitting hexagonal projection 52.

The spanner unit 60 is composed of a spanner 61, a washer 62 and a screw 63. The spanner 61 is made of an elongate strip of a certain thickness, provided with a fitting hole 611 of a plum blossom shape with teeth to fit around the fitting hexagonal end 52 of the bolt 50 and a grip portion 612 formed in a rear end for a user to grip the spanner 60. The washer 62 has a center hole 621 to align to the threaded hole 53 of the hexagonal bolt 50 to let the screw 63 to pass through to engage with the threaded hole 53.

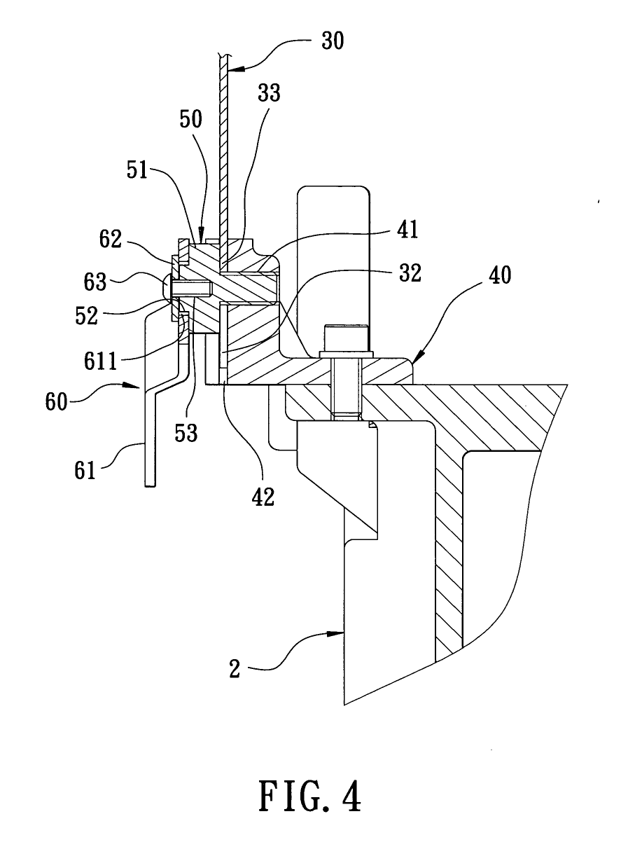

Next, in assembling the quickly collapsible dividing plate base unit, as shown in FIGS. 3 and 4, firstly the position portion 31 of the dividing plate 30 is fitted between the two slide grooves 42 of the fixing base 40, and the hexagonal bolt 50 is screwed in the threaded hole 41 of the fixing base 40, locking completely the dividing plate 30 on the fixing base 40. Next, the fitting hole 611 of the spanner 61 is fitted around the fitting projection 52 of the hexagonal bolt 50, and then the screw 63 is passed through the washer 62 and engaged with the threaded hole 53 of the fitting projection 52, finishing quickly assembly of the dividing plate base unit 3. As the fitting hole 611 is provided with the plum blossom shape with teeth, able to fit with the hexagonal fitting projection 52 in various locations, so a user can handle the spanner 61 in various different directions for pushing upward or downward the spanner 61 so that the hexagonal bolt 50 may be fixed tightly with the fixing base 40 for assembling quickly the dividing plate 30 with the fixing base 40.

On the contrary, if the dividing plate 30 is to be collapsed, lift up the grip portion 612 of the spanner 61, and swing to rotate the hexagonal bolt 50, letting the hexagonal bolt 50 loosen from the dividing plate 30. Then the dividing plate 30 can quickly be separated from the fixing base 40. Therefore, the spanner 61 can directly manually be handled to quickly collapse the dividing plate base unit 3, without using any tool.

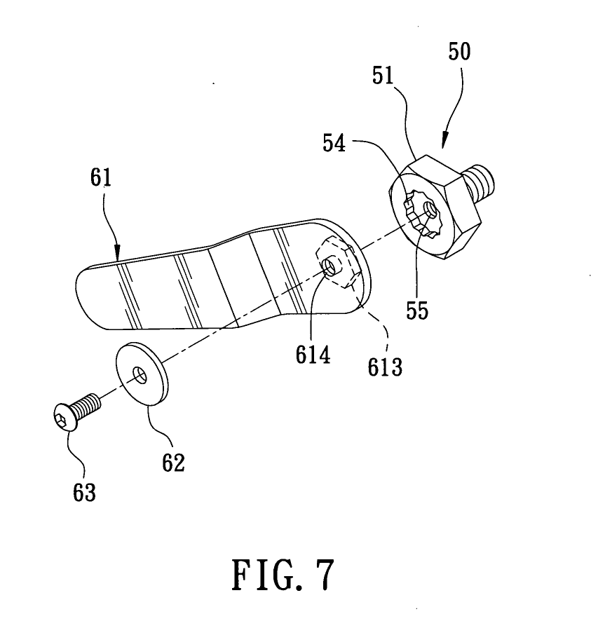

Furthermore, FIG. 7 shows a second preferred embodiment of a dividing plate base unit for a table sawing machine in the present invention, which has almost the same function and structure, except the hexagonal bolt 50 and the spanner 61. The hexagonal bolt 50 in the second preferred embodiment is provided with a head 51, and a fitting hole 54 formed in the upper portion of the head 51 and shaped as a plum blossom shape with teeth as the fitting hole 611 of the spanner 61 of the first embodiment. The spanner 61 is provided with a fitting projection 613 in a front end shaped as a hexagon to fit in the fitting hole 54 of the head of the hexagonal bolt 50. Further, a through hole 614 is provided in the fitting projection 613 for the screw 63 to pass through, also through the washer 62 and then engage with the threaded hole 55 of the hexagonal bolt 50. As the fitting hole 54 is shaped as a plum blossom shape with teeth to fit with the fitting projection 613 in various ways, so a user can handle the spanner 61 in various different directions as the same ways in using the first embodiment.

As can be seen from the foresaid description, the quickly collapsible dividing plate base unit in the present invention has the following advantage.

After the spanner unit is assembled, only lift up the grip portion of the spanner and then swing it to rotate the hexagonal bolt to let the same bolt quickly loosened from the dividing plate, which is then also quickly loosened from the fixing base at the same time. Moreover, in collapsing, no tool is necessary, so its handling is very quick, saving time and boosting working effect.

While the preferred embodiments of the invention have been described above, it will be recognized and understood that various modifications may be made therein and the appended claims are intended to cover all such modifications that may fall within the spirit and scope of the invention.

What is claimed is:

1. A quickly collapsible dividing plate base unit for a table sawing machine, said dividing plate base unit comprising:
a dividing plate provided with an elongate slot in a lower end;
a fixing base fixed inside a machine body and having a threaded hole in one side facing to said elongate slot of said dividing plate and a pair of symmetrical slide grooves formed at two ends;
a hexagonal bolt provided with a hexagonal fitting projection formed on an upper surface of a head of said hexagonal bolt; and,
a spanner unit composed of a spanner and a screw, said spanner provided with a fitting hole in a front end, said fitting hole fitting around said hexagonal fitting projection of said hexagonal bolt, said screw passing through said fitting hole and then engaging with threaded hole of said hexagonal bolt, said spanner connected with said hexagonal bolt by means of said fitting hole fitting stably around said fitting projection.

2. The quickly collapsible dividing plate base unit for a table sawing machine as claimed in claim 1, wherein said spanner unit further includes a washer with a center hole.

3. The quickly collapsible dividing plate base unit for a table sawing machine as claimed in claim 1, wherein said fitting projection of said hexagonal bolt is shaped hexagonal, and said fitting hole is shaped as a plum blossom with teeth.

4. The quickly collapsible dividing plate base unit for a table sawing machine as claimed in claim 1, wherein said hexagonal bolt is provided with a fitting hole of a plum blossom shape with teeth, and said spanner is provided with a hexagonal projection on a lower end.

5. The quickly collapsible dividing plate base unit for a table sawing machine as claimed in claim 1, wherein said spanner is shaped elongate.

6. The quickly collapsible dividing plate base unit for a table sawing machine as claimed in claim 1, wherein said spanner has a grip portion formed in a rear end portion
